(19) United States
(12) Patent Application Publication
(10) Pub. No.: US 2008/0030429 A1
(43) Pub. Date: Feb. 7, 2008

(54) SYSTEM AND METHOD OF ENHANCED VIRTUAL REALITY

(75) Inventors: Joshua M. Hailpern, Katonah, NY (US); Peter K. Malkin, Ardsley, NY (US)

Correspondence Address: CANTOR COLBURN LLP-IBM YORKTOWN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,839

(22) Filed: Aug. 7, 2006

(51) Int. Cl. G09G 5/00

(52) U.S. Cl. 345/8

(57) ABSTRACT

A method and system for virtual reality imaging is presented. The method includes placing a user in a known environment; acquiring a video image from a perspective such that a field of view of the video camera simulates the user's line of sight; tracking the user's location, rotation and line of sight; filtering the video image to remove video data associated with the known environment without effecting video data associated with the user; overlaying the video image after filtering onto a virtual image with respect to the user's location to generate a composite image; and displaying the composite image in real time at a head mounted display. The system includes a head mounted display; a video camera disposed at the head mounted display such that a field of view of the video camera simulates a line of sight of a user when wearing the head mounted display, wherein a video image is obtained for the field of view; a tracking device configured to track the location, rotation, and line of sight of a user; and a processor configured to filter the video image to remove video data associated with a known environment without effecting video data associated with the user and to overlay the video image after it is filtered onto a virtual image with respect to the user's location to generate a composite image which is displayed by the head mounted display in real time.

### BACKGROUND OF THE INVENTION

1. Field of the Invention

This invention relates to virtual reality, and particularly to a dynamically enhanced virtual reality system and method.

2. Description of Background

Before our invention, users of virtual reality have had difficulty in becoming fully immersed in the virtual space. This has been due to a lack of self, i.e., grounding themselves in the virtual world, which can result in a lack of belief of the virtual experience to disorientation and nausea.

Presently, when a user enters a virtual reality or world, their notion of self is supplied by having a perspective themselves in the virtual reality, i.e., a feeling that they are looking through their own eyes. To achieve this, a virtual world is constructed, and a virtual camera is placed in the world. Dual virtual cameras are utilized for the parallax inherent in simulated three-dimensional views. A tracking device placed on the head of the user usually controls the camera height in the virtual space. The virtual camera determines what the virtual picture is, and renders that image. The image is then passed to a head mounted display (HMD), which displays the image on small monitors within the helmet, typically one for each eye. This gives the user a perception of depth and perspective in the virtual world. However, simply having perspective is not enough to simulate reality. Users must be able to, in effect, physically interact with the world. To accomplish this, a virtual hand or pointer is utilized, and its movement is mapped by use of a joystick, placing a tracking device on a user's own hand or a tracking device on the joy stick itself.

Users become disoriented, dizzy or nauseous in this virtual world because they have no notion of physical being in this virtual world. They have the perception of sight, but not of self in their vision. Even the virtual hand looks foreign, and disembodied. In an attempt to reduce this sensation a virtual body is rendered behind the virtual camera, so that when a user looks down, or moves their hand (where the hand has a tracking device on it), he/she will see a rendered body. This body, however, is poorly articulated as it can only move in relation to user's real body if there are tracking devices on each joint/body part, and looks little or nothing like the user's own clothing or skin tone. Furthermore, subtle motion, e.g., closing fingers, bending elbow, etc., are typically not tracked, because such would require an impractical number of tracking devices. Even with this virtual body, users have trouble identifying with the figure, and coming to terms with how their motion in the real world relates to the motion of the virtual figure. Users have an internal perception of the angle they are holding their hand or arm, and if the virtual hand, or pointer does not map directly, they feel disconnected from their interaction. When motion is introduced to the virtual experience, the notion of nausea, and disorientation is increased.

An approach to addressing the lack of feeling one's self in the virtual world has been to use a large multi-wall projection system, combined with polarized glasses, commonly called a CAVE. The different images are simulating a parallax. The two images are separated using glasses; so one image is shown to each eye, and a third dimension is created in the brain when the images are combined. Though this technique allows the user to have a notion of self, by seeing their own body, in most cases, the task of combining these two images, i.e., one presented to each eye, in the brain causes the user a head-ache and in some cases nausea thus limiting most users time in the virtual space. Also, with any type of projection technology, real life objects interfering with the light projection will cast shadows, which leave holes in the projected images, or causes brightness gradients. This approach often has side effects, e.g., headaches and nausea, making it impractical for general population use, and long-term use. In addition to the visual problems, the notion of depth is limited as well. Though the images generated on the walls appear to be in three-dimension, a user cannot move their hand through the wall. To provide interaction with the three-dimensional space, the virtual world must appear to move around the user to simulate motion in the virtual environment, if the user wished to have his/her hand be the interaction device. Alternatively a cursor/pointer must appear to move further away from and closer to the user in virtual space. Thus the methods of interaction appear to be less natural.

Another approach to addressing the lack of feeling one's self in the virtual world has been to use large televisions, projectors, or computer monitors to display the virtual world to a user in a room, or sitting in a car. These devices are seen in driving and flight simulators, as well as police training rooms and arcades. Though the images appear to be more real, the user's interaction with the projected virtual environment is limited, because users cannot cross through a physical wall or monitor. Thus interaction with the virtual environment is more passive because objects in the virtual space must remain virtual, and cannot physically get closer to a user due to the physical distance a user is standing from the display device. The car, room, or other device can be tilted or moved in three-dimensional space allowing for the simulation of acceleration. The mapping of virtual environment to the perceived motion can help convince the user of the reality of the virtual world.

As a result of these limitations, head mounted display (HMD) usage in virtual reality is quite limited. In addition, real life simulations are not possible with current technologies, since users do not feel as if they are truly in the virtual world. To a further degree, real objects near a user, e.g., clothing, a chair, the interaction device etc., are also not viewable in the virtual world, further removing the user from any object that is known to them in the real world. Though a fun activity at amusement parks, without a solution to this disorientation problem, real world applications are generally limited to more abstract use models.

### SUMMARY OF THE INVENTION

The shortcomings of the prior art are overcome and additional advantages are provided through the provision of a method and system for virtual reality imaging. The method includes placing a user in a known environment; acquiring a video image from a perspective such that a field of view of the video camera simulates the user's line of sight; tracking the user's location, rotation and line of sight, all relative to a coordinate system; filtering the video image to remove video data associated with the known environment without effecting video data associated with the user; overlaying the video image after filtering onto a virtual image with respect to the user's location relative to the coordinate system, wherein a composite image is generated; and displaying the composite image in real time at a head mounted display to a user wearing the head mounted display. The method includes a head mounted display; a video camera disposed at the head mounted display such that a field of view of the video camera simulates a line of sight of a user when wearing the head mounted display, wherein a video image is obtained for the field of view; a tracking device configured to track the location, rotation, and line of sight of a user, all relative to a coordinate system; a processor in communication with the head mounted display, the video camera, and the tracking system, wherein the processor is configured to filter the video image to remove video data associated with a known environment without effecting video data associated with the user, where the processor is further configured to overlay the video image after it is filtered onto a virtual image with respect to the user's location relative to the coordinate system to generate a composite image; and wherein the head mounted display in communication with the processor displays the composite image in real time.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

The technical effect provided is the overlaying of the real image and the virtual image resulting in the composite image, which is displayed at the head mounted display. This composite image provides a virtual reality experience without the lack of self-involvement feeling and is believed to significantly reduce the feeling of nausea and dizziness, all of which are commonly encountered in prior art systems.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an environment and a system for processing all input and rendering/generating all output;

FIG. 2 illustrates one example of a configuration, in which one user is placed in the environment;

FIG. 3 illustrates one example of a configuration, in which one or more objects are placed in the environment;

FIG. 4 illustrates one example of a configuration, in which one or more other users are placed in the environment;

FIG. 5 illustrates one example of an interpretation of a user, noting explicitly their head, body, and any device that could be used to interact with the system;

FIG. 6 illustrates one example of a configuration of a user's head, wherein an immersive display device, a video-capable camera, and a rough line of sight of the video-capable camera, and their relation to the human eye is provided;

FIG. 7 illustrates one example of a block diagram of the system;

FIG. 8 illustrates one example of a flow chart showing system control logic implemented by the system; and

FIG. 9 illustrates one example of a flow chart showing the overall methodology implemented in the system.

The detailed description explains the preferred embodiments of the invention, together with advantages and features, by way of example with reference to the drawings.

### DETAILED DESCRIPTION OF THE INVENTION

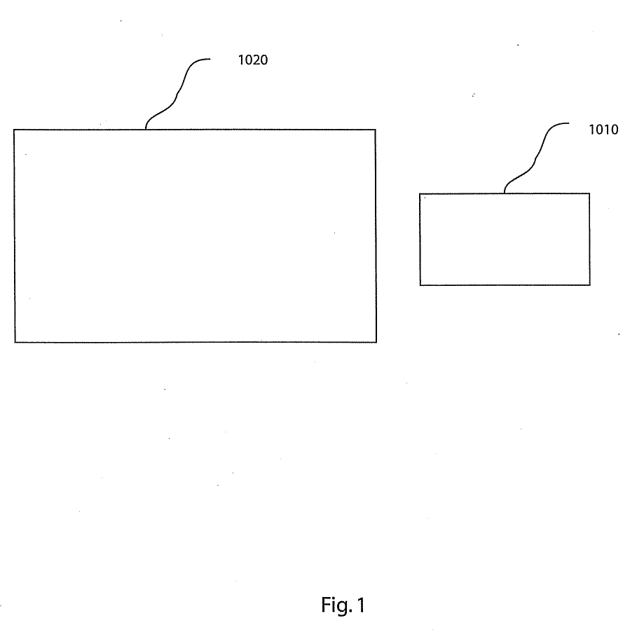

Turning now to the drawings in greater detail, it will be seen that in FIG. 1 there is an exemplary topology comprising two portions; a known environment 1020, and a system 1010. It is readily appreciated that this topology can be made more modularized. In this exemplary embodiment, the known environment 1020 is a room of a solid, uniform color. It will appreciated that the known environment 1020 is not limited to a solid uniform color room, rather other methods for removing a known environment from video are known and may me applicable.

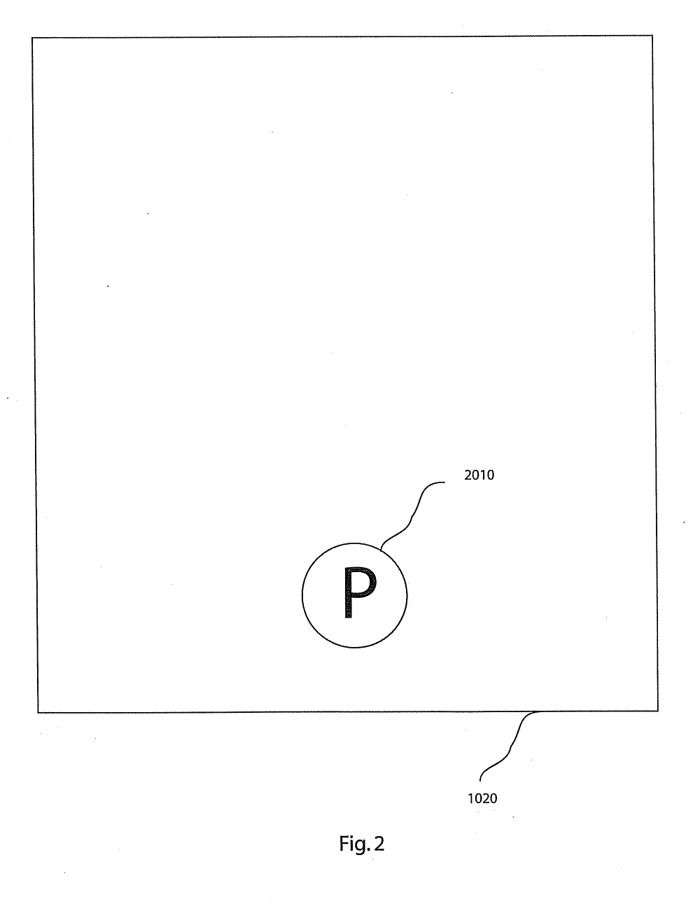

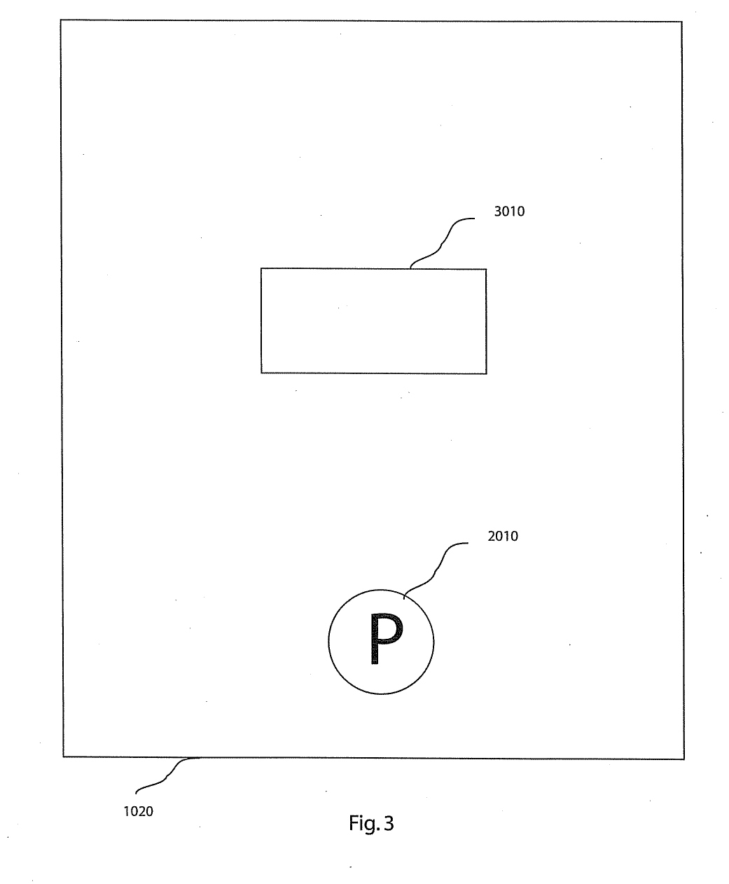

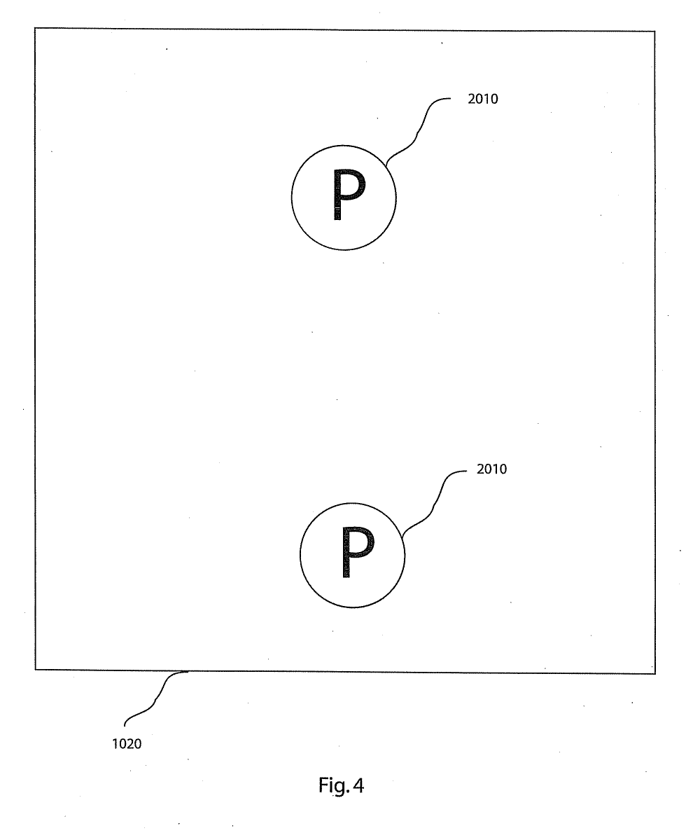

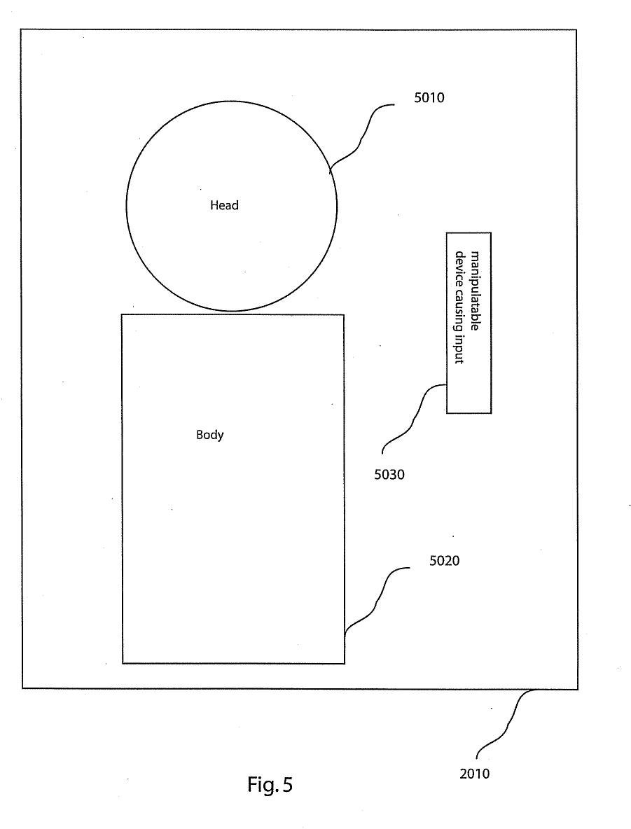

Turning also to FIGS. 2-5, there are examples shown of any number of objects 3010 (FIG. 3) and/or users (or people) 2010 to be placed in the known environment 1020. A user 2010 (FIG. 5) is described as having a head 5010, a body 5020, and optionally at least one device 5030, which can manipulate the system 1010 by generating an input. One input device 5030 may be as simple as a joystick, but is not limited to such as such input devices are continuously being developed. Another input device 5030 is a tracking system, which is able to determine the height (Z-axis) of the user, the user's position (X-axis and Y-axis), and the rotation/tilt of the user's head, relative to a defined coordinate system. The input device 5030 may also track other objects, like the user's hand, other input devices, or non-animate objects.

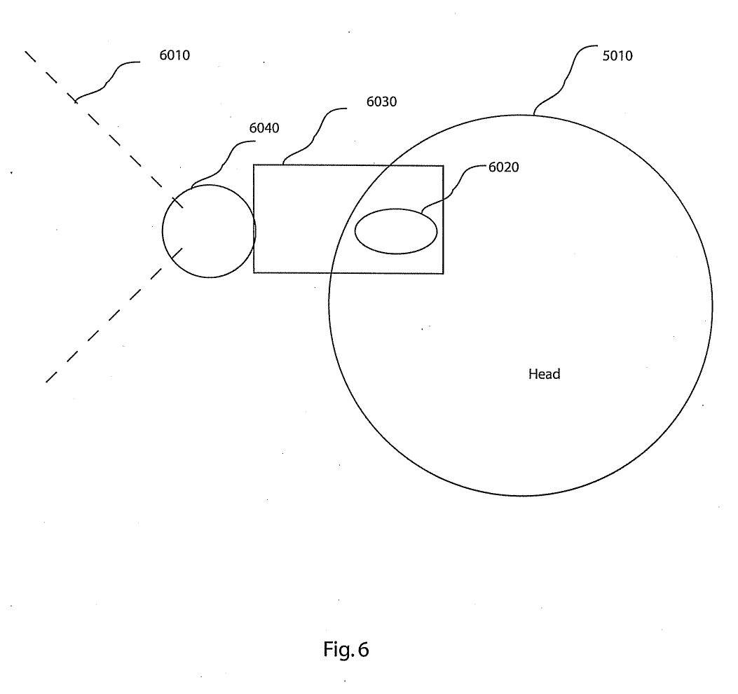

Turning now to FIG. 6, there is an example shown of an immersive display device 6030, which is configured for attachment to the user's head 5010. An example of such a device is a Head Mounted Display or HMD, such are well known. The HMD is fed a video feed from the system 1010, and the video is displayed to eyes 6020 at head 5010 via a small monitor in the HMD, which fills up the field of view. As is typical in HMDs, the HMD provides covering around eyes 6020, which when worn hides any peripheral vision. In addition to a standard immersive display device 6030, a video camera 6040 is mounted on the device 6030. The field of view 6010 of the camera 6040 is configured to be inline with the eyes 6020, which allows images captured by the video camera 6040 to closely simulate the images that would otherwise be captured by eye 6020 if the display device 6030 were not mounted on the head 5010. It will be appreciate that the video camera 6040 may alternatively be built into the display device 6030.

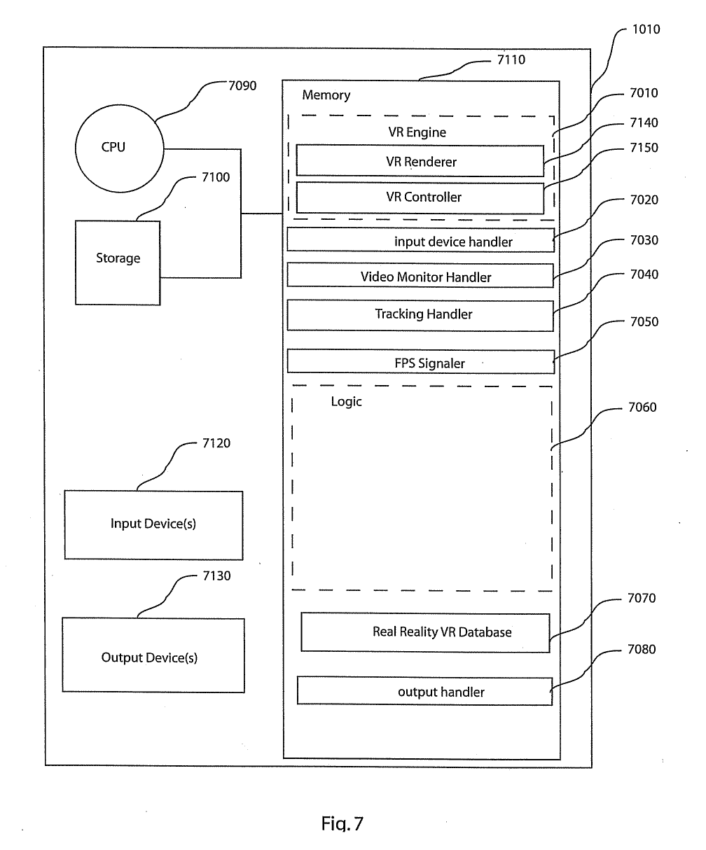

Turning now to FIG. 7, there is an example shown of the system 1010, which exist in parallel to the known environment 1020 (and the objects 3010 and users or people 2010). The system 1010 includes a processor 7090 (such as a central processing unit (CPU)), a storage device 7100 (such as a hard drive or random access memory (RAM)), a set of input devices 7120 (such as tracking system 5030, joystick 5030, video camera 6040, or a keyboard), and a set of output devices 7130 (such as head mounted display 6030, a force feedback device, or a set of speakers). These are operably interconnected as is well know. A personal computer (PC) or a laptop computer would suffice as such typically include the above components. A memory configuration 7110 is defined to store the requisite programming code for the virtual reality. Memory configuration 7110 includes a virtual reality engine 7010 that has a virtual reality renderer 7140 and a virtual reality controller 7150. A plurality of handlers are provided, which include an input device handler 7020 for handling operations for input devices 7120, a video monitor handler 7030 for handling operations of video camera 6040, and a tracking handler 7040 for handling operations of tracking system 5030. A frames per second (FPS) signaler 7050 is provided to control video to the HMD 6030. Logic 7060 defines the virtual reality for the system 1010. A real reality virtual reality database 7070 is provided for storing data, such as video data, tracking data, etc. Also, an output handler 7080 is provided for handling operations of the output devices 7130.

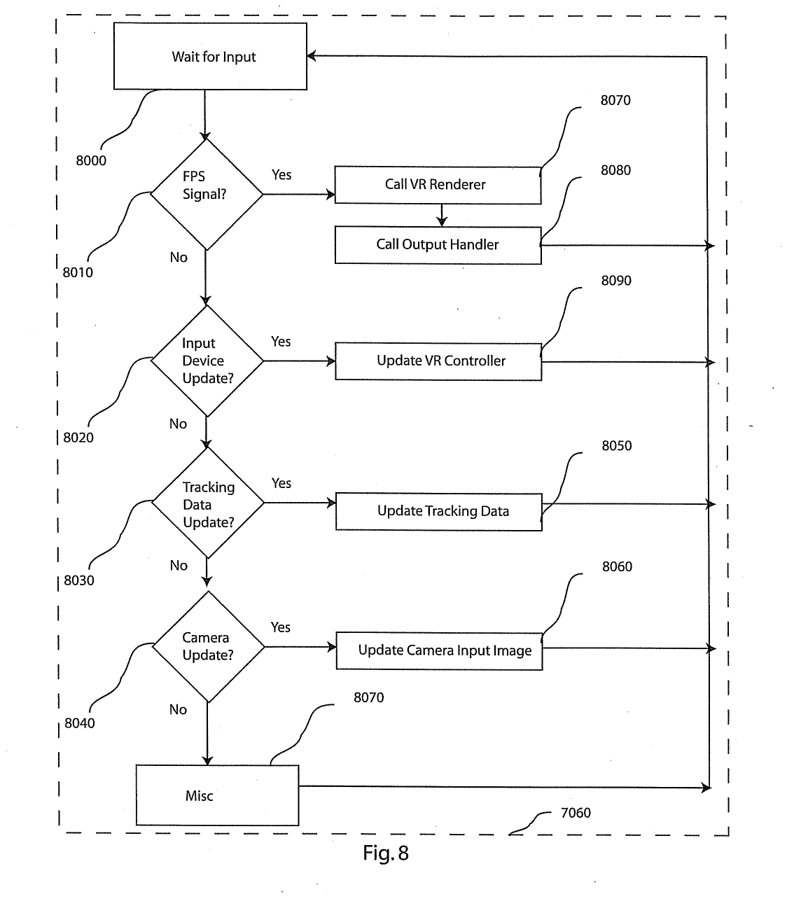

Turning now to FIG. 8, there is an example shown of logic flow 7060 for the system 1010. An input is detected at an operation Wait for Input 8000, whereby the appropriate handler is called as determined by queries FPS Signal? 8010, Input Device Update? 8020, Tracking Data Update? 8030, and Camera Update? 8040.

If the input is a FPS signal, then an operation Call VR Render 8070 is executed, wherein virtual reality renderer 7140 in the virtual reality engine 7010 is invoked. This is followed by an operation Call Output Handler 8080, wherein output handler 7080 is invoked. Following this, control returns to operation Wait for Input 800.

If the input is an input device signal, then an operation Update VR Controller 8090 is executed. The input device signal is to be used as a source of input to the virtual reality controller 7150 in the virtual reality engine 7010. This results in the input device handler 7020 being called, which alerts the virtual reality controller 7150 in the virtual reality engine 7010 about the new input, which makes the appropriate adjustments internally. If the input has additional characteristics, appropriate steps will process the input. Following this, control returns to operation Wait for Input 800.

If the input is tracking data, then an operation Update Tracking Data 8050 is executed. The tracking data is used for tracking of a user 2010 or object 3010 in the known environment 1020. This results in the tracking handler 7040 being is notified. The tracking handler 7040 stores the positional data in the database 7070 by either replacing the old data, or adding it to a queue of data points. Following this, control returns to operation Wait for Input 800.

If the input is a video camera input, then an operation Update Camera Input Image 8060 is executed, wherein the video monitor handler 7030 is called and performs the operation of updating the video data (which may be a video data steam). The video monitor handler 7030 stores the new image data in a database 7070 by either replacing the old data, or adding it to a queue of data points. Following this, control returns to operation Wait for Input 800.

If the input is not one of the above types, then a miscellaneous handler (not shown) is invoked via an operation Miscellaneous 8070. Following this, control returns to operation Wait for Input 800.

Further, an input could signal more than one handler, e.g., the video camera 6040 could be used for tracking as well as the video stream.

In order to simulate motion, the mind typically requires about 30 frames (pictures) per second to appear before eye 6020. In order to generate the requisite images, the FPS signaler 7050 activates at least about 30 times every second. Each time the FPS signaler 7050 activates, the virtual reality renderer 7140 in the virtual reality engine 7010 is called. The virtual reality renderer 7140 queries the database 7070, and retrieves the most relevant data in order to generate the most up-to-date virtual reality image simulating what a user would see in a virtual reality world given their positional data and the input to the system. Once the virtual reality image is generated it is stored in the database 7070 as the most up-to-date virtual reality composite. The output handler 7080 is then activated, which retrieves the most recent camera image from the database 7070, and overlays it on top of the more recent virtual reality rendering by using chroma-key filtering (as is known) to eliminate the single color known environment, and allow the virtual reality rendering to show through. Further filtering may occur, to filter out other data based on other input to the system, e.g., distance between objects data, thus filtering out images of objects beyond a certain distance from the user. This new image is then passed to the output devices 7130 that require the image feed. Simultaneously, the output handler 7080 gathers any other type of output necessary (e.g., force feedback data) and passes it to the output handler 7130 for appropriate distribution.

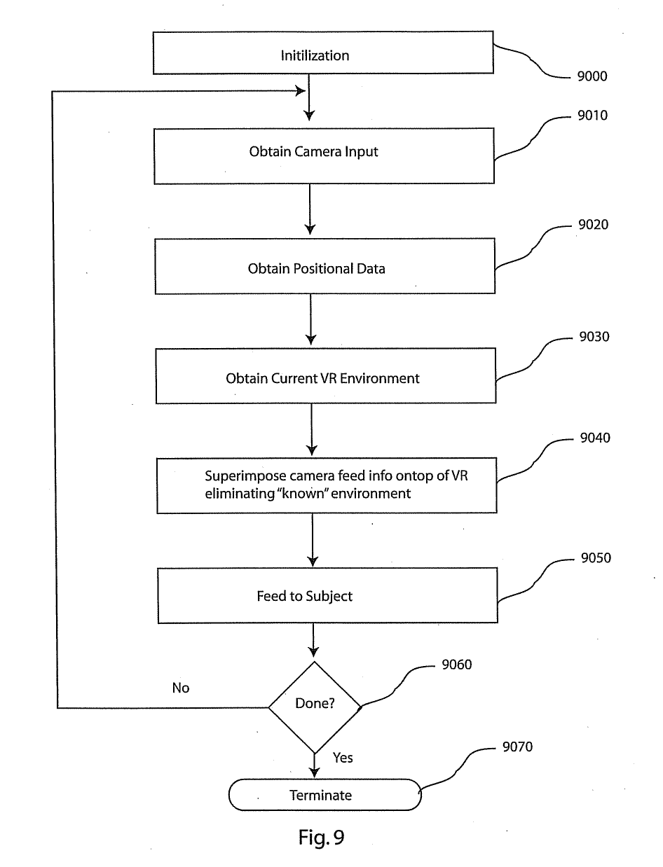

Turning now to FIG. 9, there is an example shown of a top-level process flow of the system 1010. A first step is initialization at 9000, which comprises placing the user 2010 in the known environment 1020, initializing the system 1010, and initializing/calibrating the tracking system 5030, the video camera 6040, and any other input devices. Following initialization 9000 an output for the user 2010 is created. This is done at a step 9010 by gathering the most recent image gathered by the video camera 6040. Followed by a step 9020 of gathering the most recent positional data of the user 2010, so as to determine the X, Y Z of the body 5020, and the Z and rotation position of the user's line of site. This is then followed by a step 9030 of gathering the most recent rendering of the virtual reality environment based on any input to the system, e.g., positional data gathered by step 9020. Thereafter, in a step 9040 the camera feed has a form of filtering applied to it to remove the known environment though a filtering process. One example of a filtering process is chroma-key filtering, removing a solid color range from an image, as discussed above. The resulting image are then be overlaid on top of the most recent virtual reality rendering gathered at step 9030 with the removed known environment areas of the image being replaced by the corresponding virtual reality image. This composite generated in step 9040, is then fed to the user 2010 at a step 9050. Other methods of image filtering, and combining can be used to create an output image for such things as stereoscopic images, such being readily apparent to one skilled in the art. After the image is fed to the user, the control continues back to step 9010, unless the system determines that the loop is done at a step 9060. If it is determined that the invention's use is done, the process is terminated a step 9070.

One with regular skill in the art will appreciate that the term VR includes, but is not limited to a graphics engine which generates a 3D world. Examples of VR are, but are not limited to, Panda 3D, CAD, and Alice.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for virtual reality imaging, comprising:
placing a user in a known environment;
acquiring a video image from a perspective such that a field of view of the video camera simulates the user's line of sight;
tracking the user's location, rotation and line of sight, all relative to a coordinate system;
filtering the video image to remove video data associated with the known environment without effecting video data associated with the user;
overlaying the video image after filtering onto a virtual image with respect to the user's location relative to the coordinate system, wherein a composite image is generated; and
displaying the composite image in real time at a head mounted display to a user wearing the head mounted display.

2. The method of claim 1 further comprising:
placing an object in the known environment;
tracking the object's location relative to the coordinate system; and
wherein said filtering the video image further includes filtering without effecting video data associated with the object.

3. The method of claim 1 where the known environment comprises a room of a solid, uniform color.

4. The method of claim 4 wherein said filtering comprises chroma-key filtering to remove the solid color from the video image.

5. A system for virtual reality imaging, comprising:
a head mounted display;
a video camera disposed at said head mounted display such that a field of view of the video camera simulates a line of sight of a user when wearing said head mounted display, wherein a video image is obtained for the field of view;
a tracking device configured to track the location, rotation, and line of sight of a user, all relative to a coordinate system;
a processor in communication with said head mounted display, said video camera, and said tracking system, wherein said processor is configured to filter the video image to remove video data associated with a known environment without effecting video data associated with the user, where said processor is further configured to overlay the video image after it is filtered onto a virtual image with respect to the user's location relative to the coordinate system to generate a composite image; and
wherein said head mounted display in communication with said processor displays the composite image in real time.

6. The system of claim 5 wherein said processor is further configured to filter using chroma-key filtering.

7. The system of claim 5 wherein:
said tracking device is further configured to track the location of an object relative to the coordinate system; and
said processor is further configured to filter without effecting video data associated with the object.

8. The system of claim 5 wherein said processor further comprises:
a virtual reality engine including a virtual reality renderer and virtual reality controller, said virtual reality renderer in communication with said virtual reality controller retrieves data and generates the virtual image.

9. The system of claim 5 wherein said processor further comprises:
a frame per second signaler activates said virtual reality renderer at, at least about 30 times per second.

10. The system of claim 5 wherein said processor comprises a computer.

11. The system of claim 6 wherein:
the known environment comprises a room of a solid, uniform color, and where the chroma-key filtering removes the solid color from the video image.
